(19) United States
(12) Patent Application Publication
(10) Pub. No.: US 2016/0174740 A1
(43) Pub. Date: Jun. 23, 2016

(54) METHOD AND APPARATUS FOR KIDS EATING UTENSILS

(71) Applicant: Wenzhou Jolin Table Utensils Ltd., Wenzhou (CN)

(72) Inventor: Jianyao HUANG, Wenzhou (CN)

(73) Assignee: Wenzhou Jolin Table Utensils Ltd., Wenzhou (CN)

(21) Appl. No.: 15/055,435

(22) Filed: Feb. 26, 2016

(30) Foreign Application Priority Data
Jun. 13, 2011 (CN) 201120198653.7

(51) Int. Cl. A47G 21/14; A47G 21/04; B26B 3/02; A47G 21/02

(52) U.S. Cl. CPC A47G 21/145; A47G 21/02; A47G 21/04; B26B 3/02

(57) ABSTRACT

The present utility model provides a tableware and a tableware set. The tableware comprises a dining part (10) and a handle (20) having a gripping part in the middle, wherein the gripping part has a smaller cross-section than two ends of the handle. The tableware set comprises the tableware and a hollow base (40) matching the tableware, wherein the base (40) comprises a top opening (41) for accommodating the tableware and a bottom support structure for supporting the tableware. The tableware of the present utility model not only can be conveniently held and avoid dropping from user's hand, but also has a simple structure and is easy to manufacture.

### CROSS REFERENCE TO RELATED APPLICATIONS

Pursuant to 35 U.S.C. §119(a), this application claims the benefit of earlier filing date and right of priority to Chinese Patent Application No. 201120198653.7, filed on Jun. 13, 2011, the contents of which are hereby incorporated by reference herein. in its entirety.

### TECHNICAL FIELD

The present utility model relates to the field of catering, and particularly relates to tableware and tableware sets.

### BACKGROUND

There are various types of tableware for children such as knives, forks and spoons. The gripping part of such tableware usually has many different structures as well. At present, the gripping part of the tableware for children generally has a flat structure or a cylindrical three-dimensional structure, which are often inconvenient for children to hold, or easy to be dropped from children's hands, thus causing great inconvenience to children when they use such tableware in dining.

### Contents of the Utility Model

The present utility model aims to provide a tableware and a tableware set, which not only can be held conveniently and avoid dropping from a user's hand, but also have a simple structure and are easy to manufacturer.

In order to achieve the above purpose, one aspect of the present utility model provides a tableware, which comprises a dining part and a handle, wherein the handle has a gripping part in the middle with a smaller cross section than two ends of the handle.

Further, the griping part is a structure inwardly depressed in an arc along the longitudinal surface.

Further, the tail end of the handle is a smooth cambered-surfaced structure.

Further, the tableware comprises a gong-mouth part which is used to connect the dining part with the handle, wherein the gong-mouth part cooperates with the handle to form a smooth transition structure.

Further, the dining part is a knife, a fork or a spoon.

Another aspect of the present utility model provides a tableware set, which comprises the above tableware and a base matching the tableware, wherein the base comprises a top opening for accommodating the tableware and a bottom support structure for supporting the tableware.

Further, the gong-mouth part arranged between the dining part and the handle has a positioning structure matching the base. The base has a body which cooperates with the gong-mouth part so as to form a smooth transition structure.

According to the technical solution of the present utility model, the tableware comprises a dining part and a handle having an structure in the middle that is inwardly depressed in an arc, such that a user can hold the inwardly depressed structure of the handle when using the tableware and thus the tableware is not easy to drop from his or her hand. The tail end of the handle is a smooth cambered-surfaced structure, which gives the user a comfortable gripping feeling and will not cause any harm to the user.

### DESCRIPTION OF THE FIGURES

For the purpose of better understanding the present utility model, the accompanying drawings are provided as a part of the present utility model. The exemplary embodiments and the descriptions thereof are provided to explain the present utility model, which do not intend to limit the present utility model. The accompanying drawings include:

FIG. 1 is a schematic diagram of a tableware according to an embodiment of the present utility model; and

FIG. 2 is a schematic diagram of a base of a tableware set according to an embodiment of the present utility model.

### SPECIFIC EMBODIMENTS OF THE UTILITY MODEL

The following are detailed descriptions of the present utility model in view of the accompanying drawings in conjunction with the embodiments. In the absence of conflicts, the embodiments of the present application can be combined with each other, and the features in each embodiment can be combined with each other.

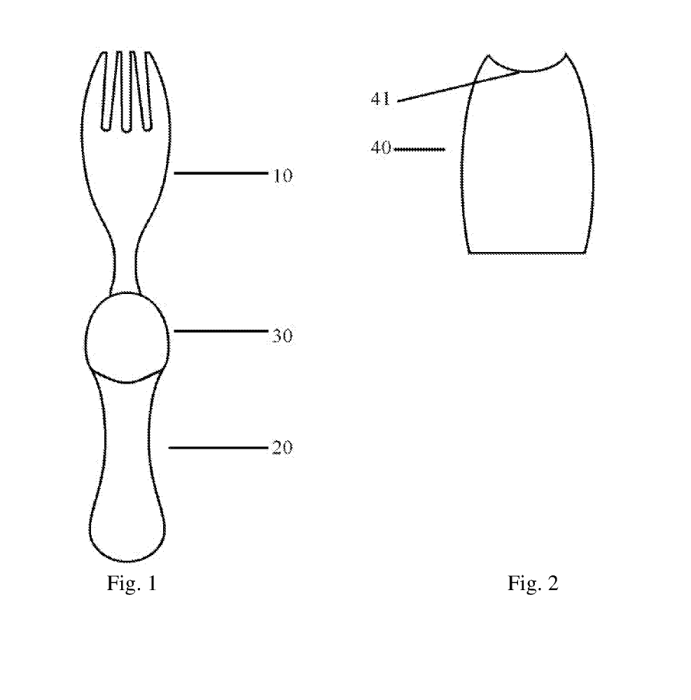

According to an embodiment of the present utility model, as shown in FIGS. 1 and 2, the tableware comprises a dining part 10 and a handle 20, wherein the handle 20 has a gripping part in the middle with a smaller cross section than two ends of the handle 20. Specifically, the gripping part has a structure inwardly depressed in an arc along the longitudinal surface of the tableware, and the tail end of the handle is a smooth cambered-surface structure. When using the tableware, a user can hold the arc-shaped inwardly depressed structure, thereby preventing the tableware from dropping from his or her hand. Also, such an arc-shaped inwardly depressed structure makes the middle portion of the handle 20 smaller than the other portions of the handle so as to facilitate the user's gripping. The smooth cambered-surfaced structure of the tail end of the handle 20 can enhance user's touch feel when he or she holds the tableware and also avoid any harm to the user that could be caused by an un-smooth structure.

There can further be a gong-mouth part 30 provided between the dining part 10 and handle 20 as a transition connection structure. Since the dining part 10 and the handle 20 are made from different materials, by using the gong-mouth part 30 that is made a material between the material of the dining part 10 and the material of the handle 20 as the connection between the dining part 10 and handle 20, the connection can be further strengthened, thereby extending the lifespan of the tableware. The gong-mouth part 30 can be provided separately, or as a part of the handle 20. When the gong-mouth part 30 is provided separately, it should have a structure which can cooperate with the handle 20 so as to form a smooth transition structure, such that a user will not feel uncomfortable even he or she grips this connecting location. The dining part 10 in the present embodiment is a knife, a fork or a spoon.

A tableware set provided in the present utility model comprises the tableware and a hollow base 40 matching the tableware. The base 40 comprises a body which cooperates with the gong-mouth part 30 so as to form a smooth transition structure. A top opening 41 at the top of the base 40 is used to accommodate the tableware. A bottom support at the bottom of the base 40 is used to support the tableware so as to ensure that the tableware stands stably after it is put into the base 40. In the present embodiment, the bottom support is a flush end-face support structure, and its body has a convex-arc structure, which makes the base 40 have enough inner space to accommodate the tableware. Preferably, the gong-mouth part 30 comprises a positioning structure matching the base 40 to facilitate positioning the tableware when it is put in the base 40 and ensure that the tableware is placed in a right position.

From the above descriptions, it can be seen that the above embodiments of the present utility model can achieve the following technical effects: as the tableware comprises a dining part and a handle having an arc-shaped inwardly depressed structure in the middle, a user when using the tableware can hold the arc-shaped inwardly depressed structure of the handle such that the tableware will easily drop from his or her hand. Besides, the tail end of the handle is a smooth cambered-surfaced structure, which brings the user a comfortable gripping feel and will not cause harm to the user.

What is described above is just preferred embodiments of the present utility model, which is not intended to limit the present utility model, and various alterations and variations could be made to the present utility model by a person skilled in the art. Any modifications, equivalent replacements and improvements within the spirit and principle of the present utility model should be included within the scope of the present utility model.

1. A tableware comprises a dining part (10) and a handle (20), characterized in that the handle (20) has a gripping part in the middle with a smaller cross section than two ends of the handle (20).

2. The tableware as recited in claim 1, characterized in that the gripping part is a structure with an arc-shaped inwardly depressed in an arc along the longitudinal surface.

3. The tableware as recited in claim 2, characterized in that the tail end of the handle (20) is a smooth cambered-surfaced structure.

4. The tableware as recited in claim 3, characterized by further comprising a gong-mouth part (30) which is used to connect the dining part (10) with the handle (20), wherein the gong-mouth part (30) cooperates with the handle (20) so as to form a smooth transition structure.

5. The tableware as recited in claim 4, characterized in that the dining part (10) is a knife, a fork or a spoon.

6. A tableware set characterized by comprising the tableware as recited in claim 1 and a hollow base (40) matching the tableware, wherein the base (40) comprises a top opening (41) for accommodating the tableware and a bottom support structure for supporting the tableware.

7. A tableware set characterized by comprising the tableware as recited in claim 2 and a hollow base (40) matching the tableware, wherein the base (40) comprises a top opening (41) for accommodating the tableware and a bottom support structure for supporting the tableware.

8. A tableware set characterized by comprising the tableware as recited in claim 3 and a hollow base (40) matching the tableware, wherein the base (40) comprises a top opening (41) for accommodating the tableware and a bottom support structure for supporting the tableware.

9. A tableware set characterized by comprising the tableware as recited in claim 4 and a hollow base (40) matching the tableware, wherein the base (40) comprises a top opening (41) for accommodating the tableware and a bottom support structure for supporting the tableware.

10. A tableware set characterized by comprising the tableware as recited in claim 5 and a hollow base (40) matching the tableware, wherein the base (40) comprises a top opening (41) for accommodating the tableware and a bottom support structure for supporting the tableware.

11. The tableware set as recited in claim 6, characterized in that the gong-mouth part (30) arranged between the dining part (10) and the handle (20) has a positioning structure matching the base (40), and the base (40) has a body which cooperates with the gong-mouth part (30) so as to form a smooth transition structure.
